(19) United States
(12) Patent Application Publication
(10) Pub. No.: US 2019/0015989 A1
(43) Pub. Date: Jan. 17, 2019

(54) Robot Control Device, Robot, Robot System, And Calibration Method Of Camera

(71) Applicant: Seiko Epson Corporation, Tokyo (JP)

(72) Inventors: Mitsuhiro INAZUMI, Shiojiri (JP); Takahiko NODA, Azumino (JP)

(21) Appl. No.: 16/031,208

(22) Filed: Jul. 10, 2018

(30) Foreign Application Priority Data
Jul. 11, 2017 (JP) 2017-135107

(51) Int. Cl. B25J 9/16

(52) U.S. Cl. CPC B25J 9/1692; B25J 9/1697

(57) ABSTRACT

A robot control device includes a processor that creates a parameter of a camera including a coordinate transformation matrix between a hand coordinate system of an arm and a camera coordinate system of the camera. The processor calculates a relationship between an arm coordinate system and a pattern coordinate system at the time of capturing the pattern image of the calibration pattern, and estimates a coordinate transformation matrix between the hand coordinate system of the arm and the camera coordinate system of the camera with the relationship between the arm coordinate system and the pattern coordinate system, a position and attitude of the arm at the time of capturing a pattern image, and the pattern image.

### BACKGROUND

### 1. Technical Field

The present invention relates to calibration of a camera for a robot.

### 2. Related Art

There are cases where a camera is installed in a robot to have a function of an eye in order to make the robot perform advanced processing. As an installation method of the camera, there are a method of installing the camera independently of a robot arm and a method of installing the camera on a robot arm (hand eye). By using a hand eye, a wider field of view can be obtained, and a field of view of the fingers working can be secured as an advantage.

In JP-A-2012-91280, a calibration method of a coordinate system in a robot system using a camera installed in an arm is disclosed. As described in JP-A-2012-91280, in the case of using the camera installed in the arm, there is a need to solve a so-called “AX=XB problem” related to an unknown transformation matrix X between a camera coordinate system and a robot coordinate system, and there is a problem that it is difficult to calibrate the camera. In the solution of the AX=XB problem, there is a no guarantee that the nonlinear optimization process will converge to an optimal solution. In order to avoid the AX=XB problem, a technique of obtaining a linearized transformation matrix of the coordinate system by limiting the movement of the robot is disclosed in JP-A-2012-91280.

However, with the technique disclosed in JP-A-2012-91280, there is a problem that the transformation matrix acquired as a processing result depends on the accuracy of the position estimation of the calibration pattern using an image. That is, in order to improve the accuracy of the position estimation of the calibration pattern, it is more advantageous when the movement of the robot is larger. However, there is a problem that the larger movement of the robot deteriorates the accuracy. On the other hand, in order to improve the accuracy of the movement of the robot, it is preferable to reduce the movement. However, there is a problem that the accuracy of the position estimation of the calibration pattern deteriorates using the image. There is a demand for a technique capable of easily performing the calibration of a camera installed in the arm by a method different from the method disclosed in JP-A-2012-91280.

### SUMMARY

An advantage of some aspects of the invention is to solve at least a part of the problems described above, and the invention can be implemented as the following aspects.

(1) According to a first embodiment of the invention, a control device that controls a robot having an arm on which a camera is installed is provided. The control device includes an arm control unit that controls the arm, a camera control unit that controls the camera, and a camera calibration execution unit that estimates a coordinate transformation matrix between a hand coordinate system of the arm and a camera coordinate system of the camera and creates a parameter of the camera including the coordinate transformation matrix. The camera control unit causes the camera to capture a pattern image of a calibration pattern of the camera. The camera calibration execution unit calculates a relationship between an arm coordinate system of the arm and a pattern coordinate system of the calibration pattern at the time of capturing the pattern image, and estimates the coordinate transformation matrix with a position and attitude of the arm at the time of capturing the pattern image, and the pattern image.

According to the control device, it is possible to determine the relationship between the arm coordinate system and the hand coordinate system from the position and attitude of the arm at the time of capturing the pattern image. Since the camera calibration execution unit can calculate the relationship between the arm coordinate system and the pattern coordinate system, in addition to the relationship, it is possible to estimate the coordinate transformation matrix between the hand coordinate system and the camera coordinate system with the relationship between the pattern coordinate system and the camera coordinate system acquired from the pattern image captured with the camera. As a result, it is possible to create the parameter of the camera including the coordinate transformation matrix and to detect a position of the target using the camera.

(2) In the control device, the camera calibration execution unit may calculate a first transformation matrix between the arm coordinate system and the hand coordinate system from the position and attitude of the arm at the time of capturing the pattern image; calculate or estimate a second transformation matrix between the pattern coordinate system and the arm coordinate system; estimate a third transformation matrix between the camera coordinate system and the pattern coordinate system from the pattern image, and calculate the coordinate transformation matrix from the first transformation matrix, the second transformation matrix, and the third transformation matrix.

According to the control device with this configuration, it is possible to calculate the first transformation matrix from the position and attitude of the arm. In addition, since the camera calibration execution unit can calculate or estimate the second transformation matrix indicating the coordinate transformation of the arm coordinate system and the pattern coordinate system, and can further estimate the third transformation matrix from the pattern image, it is possible to easily acquire the parameter of the camera including the coordinate transformation matrix between the hand coordinate system and the camera coordinate system from these transformation matrixes.

(3) In the control device, the robot may have a second arm provided with the calibration pattern set in a predetermined installation state, and the camera calibration execution unit may calculate the second transformation matrix between the pattern coordinate system and the arm coordinate system from a position and attitude of the second arm at the time of capturing the pattern image.

According to the control device with this configuration, since the second transformation matrix can be calculated from the position and attitude of the second arm, it is possible to easily acquire the coordinate transformation matrix between the hand coordinate system and the camera coordinate system.

(4) In the control device, the camera control unit may cause a fixed camera disposed independently of the arm to capture a second pattern image of the calibration pattern, and the camera calibration execution unit may estimate the second transformation matrix between the pattern coordinate system and the arm coordinate system from the second pattern image.

According to the control device with this configuration, since the second transformation matrix can be estimated from the second pattern image, it is possible to easily acquire the coordinate transformation matrix between the hand coordinate system and the camera coordinate system.

(5) In the control device, the fixed camera may be a stereo camera.

According to the control device with this configuration, since the second transformation matrix can be accurately estimated from the second pattern image captured by the stereo camera, it is possible to accurately acquire the coordinate transformation matrix between the hand coordinate system and the camera coordinate system.

(6) According to a second embodiment of the invention, a control device that controls a robot having an arm on which a camera is installed is provided. The control device includes a processor. The processor causes the camera to capture a pattern image of a calibration pattern of the camera, calculates a relationship between an arm coordinate system of the arm and a pattern coordinate system of the calibration pattern at the time of capturing the pattern image, and estimates a coordinate transformation matrix between a hand coordinate system of the arm and a camera coordinate system of the camera with a position and attitude of the arm at the time of capturing the pattern image, and the pattern image.

According to the control device, it is possible to determine the relationship between the arm coordinate system and the hand coordinate system from the position and attitude of the arm at the time of capturing the pattern image. Since it is possible to calculate the relationship between the arm coordinate system and the pattern coordinate system, in addition to these relationships, it is possible to estimate the coordinate transformation matrix between the hand coordinate system and the camera coordinate system with the relationship of the pattern coordinate system and the camera coordinate system acquired from the pattern image captured with the camera. As a result, it is possible to create the parameter of the camera including the coordinate transformation matrix and to detect a position of the target using the camera.

(7) According to a third aspect of the invention, a robot connected to the control device is provided.

According to the robot, it is possible to easily estimate the coordinate transformation matrix between the hand coordinate system and the camera coordinate system.

(8) According to a fourth aspect of the invention, a robot system including a robot and the control device connected to the robot is provided.

According to the robot system, it is possible to easily estimate the coordinate transformation matrix between the hand coordinate system and the camera coordinate system.

(9) According to a fifth embodiment of the invention, a calibration method of a camera for a robot having an arm on which the camera is installed is provided. The method includes causing the camera to capture a pattern image of a calibration pattern of the camera, calculating a relationship between an arm coordinate system of the arm and a pattern coordinate system of the calibration pattern at the time of capturing the pattern image, and estimating a coordinate transformation matrix between a hand coordinate system of the arm and a camera coordinate system of the camera with a position and attitude of the arm at the time of capturing the pattern image and the pattern image.

According to the method, it is possible to determine the relationship between the arm coordinate system and the hand coordinate system from the position and attitude of the arm at the time of capturing the pattern image. Since it is possible to calculate the relationship between the arm coordinate system and the pattern coordinate system, in addition to these relationships, it is possible to estimate the coordinate transformation matrix between the hand coordinate system and the camera coordinate system with relationship between the pattern coordinate system acquired from the pattern image captured with the camera and the camera coordinate system. As a result, it is possible to create the parameter of the camera including the coordinate transformation matrix and to detect a position of the target using the camera.

The invention can be realized in various forms other than the above. For example, the invention can be realized in forms of a computer program for realizing a function of a control device, a non-transitory storage medium on which the computer program is recorded, and the like.

### BRIEF DESCRIPTION OF THE DRAWINGS

The invention will be described with reference to the accompanying drawings, wherein like numbers reference like elements.

FIG. 1 is a schematic diagram of a robot system.

FIG. 2 is a block diagram illustrating functions of a robot and a control device.

FIG. 3 is an explanatory diagram illustrating a robot coordinate system of a first embodiment.

FIG. 4 is a flowchart illustrating a processing procedure of the first embodiment.

FIG. 5 is an explanatory diagram illustrating a robot coordinate system of a second embodiment.

FIG. 6 is a flowchart illustrating a processing procedure of the second embodiment.

FIG. 7 is an explanatory diagram illustrating a robot coordinate system of a third embodiment.

### DESCRIPTION OF EXEMPLARY EMBODIMENTS

### A. Configuration of Robot System

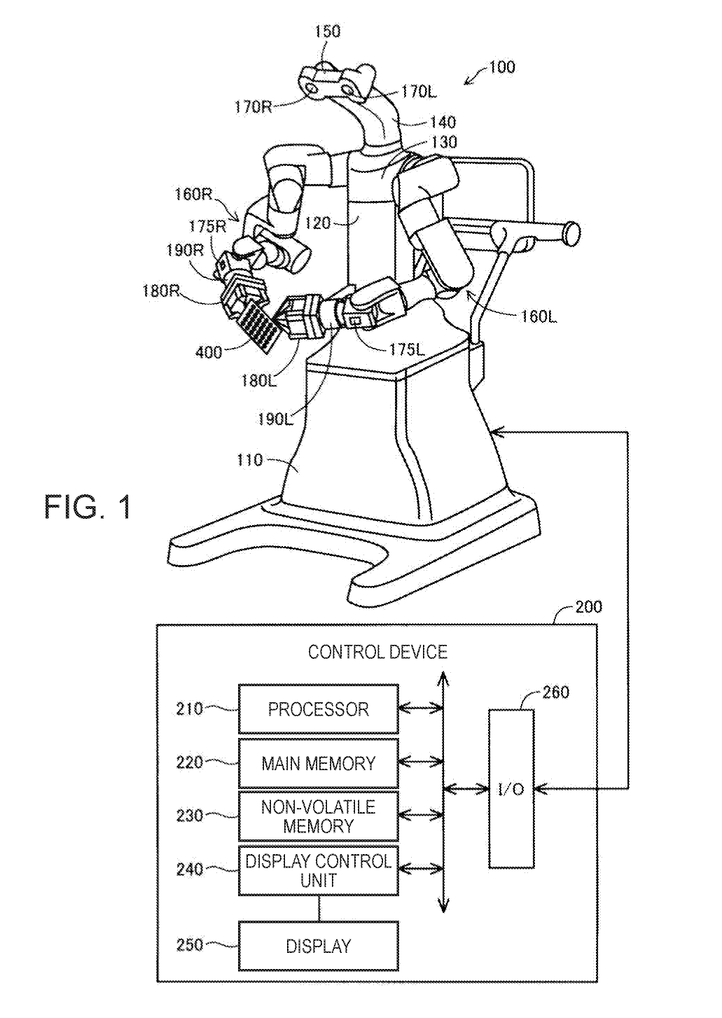

FIG. 1 is a schematic diagram of a robot system in an embodiment. The robot system is provided with a robot 100 and a control device 200. The robot 100 is an autonomous robot capable of performing work while recognizing a work target with a camera, freely adjusting force, and autonomously determining. The robot 100 can operate as a teaching playback robot for performing a work according to prepared teaching data.

The robot 100 is provided with a base 110, a body portion 120, a shoulder portion 130, a neck portion 140, a head portion 150, and two arms 160L and 160R. Hands 180L and 180R are detachably attached to the arms 160L and 160R. These hands 180L and 180R are end effectors for holding a workpiece or a tool. Cameras 170L and 170R are installed in the head portion 150. These cameras 170L and 170R are provided independently of the arms 160L and 160R, and are fixed cameras whose position and attitude are not changed. Hand eyes 175L and 175R are provided in a wrist portion of the arms 160L and 160R as a camera. A calibration pattern 400 for the cameras 170L and 170R and the hand eyes 175L and 175R can be installed in the arms 160L and 160R. Hereinafter, in order to distinguish with the hand eyes 175L and 175R, the cameras 170L and 170R provided in the head portion 150 are referred to as “fixed cameras 170L and 170R”.

Force sensors 190L and 190R are provided in a wrist portion of the arms 160L and 160R. The force sensors 190L and 190R are sensors for detecting a reaction force or a moment with respect to a force that the hands 180L and 180R exert on the workpiece. As the force sensors 190L and 190R, for example, it is possible to use a six-axis force sensor capable of simultaneously detecting six components of force components in translational three-axis directions and the moment components around three rotation axes. The force sensors 190L and 190R are optional.

The letters “L” and “R” appended to the end of symbols of the arms 160L and 160R, the cameras 170L and 170R, the hand eyes 175L and 175R, the hands 180L and 180R, and the force sensors 190L and 190R mean “left” and “right”. In a case where these distinctions are unnecessary, explanations will be made using symbols without the letters “L” and “R”.

The control device 200 includes a processor 210, a main memory 220, a non-volatile memory 230, a display control unit 240, a display 250, and an I/O interface 260. These units are connected via a bus. The processor 210 is, for example, a microprocessor or a processor circuit. The control device 200 is connected to the robot 100 via the I/O interface 260. The control device 200 may be stored in the robot 100.

As a configuration of the control device 200, various configurations other than the configuration illustrated in FIG. 1 can be adopted. For example, the processor 210 and the main memory 220 can be deleted from the control device 200 of FIG. 1, and the processor 210 and the main memory 220 may be provided in another device communicably connected to the control device 200. In this case, the entire device including the another device and the control device 200 functions as a control device of the robot 100. In another embodiment, the control device 200 may have two or more of the processors 210. In still another embodiment, the control device 200 may be realized by a plurality of devices communicably connected to each other. In these various embodiments, the control device 200 is configured as a device or a device group including one or more of the processors 210.

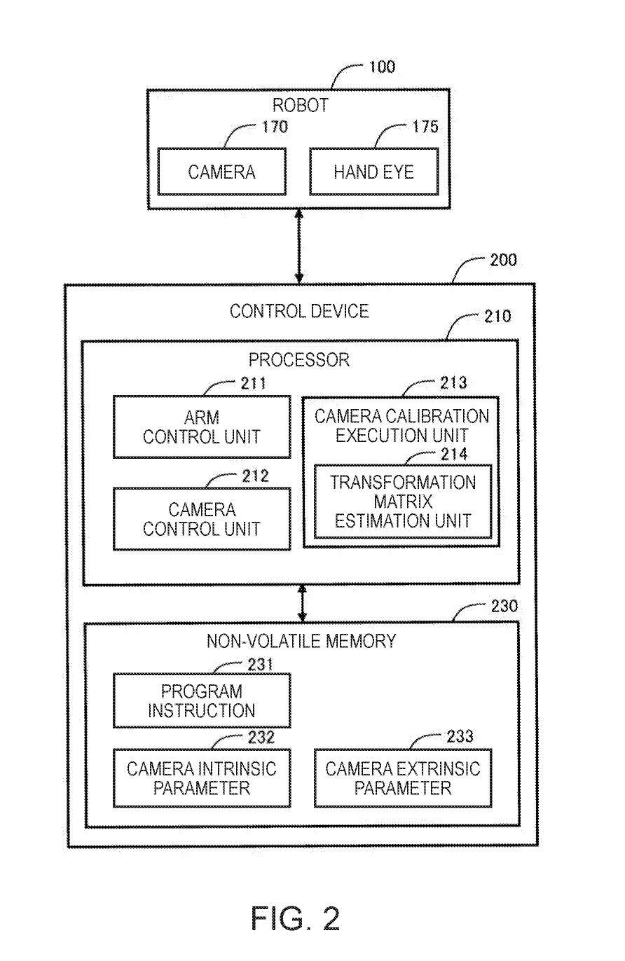

FIG. 2 is a block diagram illustrating functions of the robot 100 and the control device 200. The processor 210 of the control device 200 realizes each function of an arm control unit 211, a camera control unit 212, and a camera calibration execution unit 213 by executing various program instructions 231 previously stored in the non-volatile memory 230. The camera calibration execution unit 213 includes a transformation matrix estimation unit 214. A part or all of the functions of these units 211 to 214 may be realized by a hardware circuit. The functions of these units 211 to 214 will be described later. A camera intrinsic parameter 232 and a camera extrinsic parameter 233 are stored in the non-volatile memory 230 in addition to the program instructions 231. These parameters 232 and 233 include parameters of the fixed camera 170 and parameters of the hand eye 175, respectively. In the present embodiment, the parameters 232 and 233 of the fixed camera 170 are assumed to be known, and the parameters 232 and 233 of the hand eye 175 are unknown. In the calibration processing described later, the parameters 232 and 233 of the hand eye 175 are generated. These parameters 232 and 233 will be described later.

### B. Robot Coordinate System and Coordinate Transformation

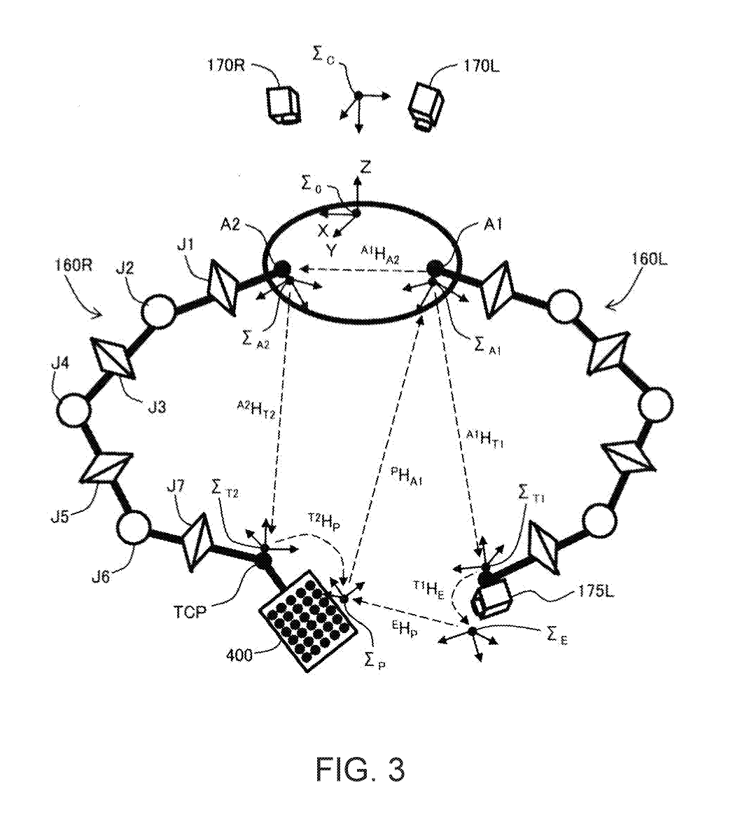

FIG. 3 is an explanatory diagram illustrating a configuration of an arm 160 of the robot 100 and various coordinate systems. Each of the two arms 160L and 160R is provided with seven joints J1 to J7. Joints J1, J3, J5, and J7 are twisting joints and joints J2, J4, and J6 are bending joints. A twisting joint is provided between the shoulder portion 130 and the body portion 120 in FIG. 1, but is not shown in FIG. 3. The individual joints are provided with an actuator for moving the joints and a position detector for detecting a rotation angle.

A tool center point (TCP) is set on at an end of the arm 160. Typically, control of the robot 100 is executed to control a position and attitude of the tool center point TCP. A position and attitude means three coordinate values in a three-dimensional coordinate system and a state defined by rotation around each coordinate axis.

In the arms 160L and 160R, the calibration pattern 400 can be set in a predetermined installation state. In the example of FIG. 3, the calibration pattern 400 used in the calibration of the hand eye 175L of the left arm 160L is fixed in the hand portion of the right arm 160R. When attaching the calibration pattern 400 to the right arm 160R, the hand 180R of the right arm 160R may be removed. The same applies to the hand 180L of the left arm 160L.

The calibration of the hand eye 175L is a process for estimating an intrinsic parameter and an extrinsic parameter of the hand eye 175L. The intrinsic parameter is a specific parameter of the hand eye 175L and the lens system thereof, and includes, for example, a projective transformation parameter, a distortion parameter, and the like. The extrinsic parameter is a parameter used when calculating the relative position and attitude between the hand eye 175L and the arm 160L of the robot 100, and a parameter expressing translation and rotation between a hand coordinate system Σ_{T1} of the arm 160L and a hand eye coordinate system Σ_{E}. The extrinsic parameter can also be configured as a parameter expressing translation and rotation between a target coordinate system other than the hand coordinate system Σ_{T1} and a hand eye coordinate system Σ_{E}. The target coordinate system may be a coordinate system capable of acquiring from a robot coordinate system Σ₀. For example, a coordinate system having a fixed known relative position and attitude with respect to the robot coordinate system Σ₀ and a coordinate system in which the relative position and attitude with the robot coordinate system Σ₀ is determined according to the movement amount of the joint of the arm 160L may be selected as a target coordinate system. The extrinsic parameter corresponds to “a parameter of a camera including a coordinate transformation matrix between a hand coordinate system of an arm and a camera coordinate system of a camera”.

In FIG. 3, the following coordinate system is drawn as a coordinate system related to the robot 100.
(1) Robot coordinate system Σ₀: a coordinate system having a reference point of the robot 100 as a coordinate origin point
(2) Arm coordinate systems Σ_{A1}, and Σ_{A2}: a coordinate system having reference points A1 and A2 as a coordinate origin point of the arms 160L and 160R
(3) Hand coordinate systems Σ_{T1}, and Σ_{T2}: a coordinate system having a tool center point (TCP) as a coordinate origin point of the arms 160L and 160R
(4) Pattern coordinate system Σ_{P}: a coordinate system having a predetermined position on the calibration pattern 400 as a coordinate origin point
(5) Hand eye coordinate system Σ_{E}: a coordinate system set in the hand eye 175

The arm coordinate systems Σ_{A1}, and Σ_{A2} and the hand coordinate systems Σ_{T1}, and E_{T2} are individually set in the left arm 160L and the right arm 160R. Hereinafter, the coordinate systems related to the left arm 160L are referred to as “first arm coordinate system Σ_{A1}”, and “first hand coordinate system Σ_{T1}”, and the coordinate systems related to the right arm 160R are referred to as “second arm coordinate system Σ_{A2}”, and “second hand coordinate system Σ_{T2}”. The relative position and attitude of the arm coordinate systems Σ_{A1}, and Σ_{A2} and the robot coordinate system Σ₀ is known. The hand eye coordinate system Σ_{E} is also individually set on the hand eyes 175L and 175R. In the description below, the hand eye 175L of the left arm 160L is set as a calibration target, and thereby the coordinate system of the hand eye 175L of the left arm 160L is used as the hand eye coordinate system Σ_{E}. In FIG. 3, for the convenience of the drawings, the origin points of an individual coordinate system are drawn at a position shifted from the actual potion.

In general, a transformation from a certain coordinate system Σ_{A} to another coordinate system Σ_{B}, or transformation of position and attitude in these coordinate systems can be expressed as a homogeneous transformation matrix ^{A}H_{B} illustrated below.

$$\begin{matrix}{}_{ }^{A}{H}{}_{B}^{ } = ( \begin{matrix}R & T \\ 0 & 1\end{matrix} ) = ( \begin{matrix}{R}_{xx} & {R}_{yx} & {R}_{zx} & {T}_{x} \\ {R}_{xy} & {R}_{yy} & {R}_{zy} & {T}_{y} \\ {R}_{xz} & {R}_{yz} & {R}_{zz} & {T}_{z} \\ 0 & 0 & 0 & 1\end{matrix} ) & ( 1 a ) \\ {R}_{x} = ( \begin{matrix}{R}_{xx} \\ {R}_{xy} \\ {R}_{xz}\end{matrix} ) & ( 1 b ) \\ {R}_{y} = ( \begin{matrix}{R}_{yx} \\ {R}_{yy} \\ {R}_{yz}\end{matrix} ) & ( 1 c ) \\ {R}_{z} = ( \begin{matrix}{R}_{zx} \\ {R}_{zy} \\ {R}_{zz}\end{matrix} ) & ( 1 d )\end{matrix}$$

Here, R represents a rotation matrix, T represents a translation vector, and Rₓ, R_{y}, and R_{z} represent column components of a rotation matrix R. Hereinafter, the homogeneous transformation matrix ^{A}H_{B} is also referred to as “coordinate transformation matrix ^{A}H_{B}”, “transformation matrix ^{A}H_{B}”, or simply “transformation ^{A}H_{B}”. The superscript “^{A}” on the left side of a transformation symbol “^{A}H_{B}” indicates the coordinate system before the transformation, and the subscript “a” on the right side of the transformation symbol “^{A}H_{B}” indicates the coordinate system after the transformation. The transformation ^{A}H_{B} can be also considered as indicating an origin position and basic vector components of the coordinate system Σ_{B} seen in the coordinate system Σ_{A}.

An inverse matrix ^{A}H_{B}⁻¹ (=^{B}H_{A}) of the transformation ^{A}H_{B} is given by the following expression.

^{A}H_{B}⁻¹=(R₀^{T}−R₁^{T}·T) (2)

The rotation matrix R has the following important properties.

### Rotation Matrix R Property 1

The rotation matrix R is an orthonormal matrix, and an inverse matrix R⁻¹ thereof is equal to a transposed matrix R^{T}.

### Rotation Matrix R Property 2

The three column components Rₓ, R_{y}, and R_{z} of the rotation matrix R are equal to three basic vector components of the coordinate system Σ_{B} after rotation seen in the original coordinate system Σ_{A}.

In a case where the transformations ^{A}H_{B} and ^{B}H_{C} are sequentially applied to a certain coordinate system Σ_{A}, a combined transformation ^{A}H_{C} is acquired by multiplying each of the transformations ^{A}H_{B} and ^{B}H_{C} sequentially to the right.

^{A}H_{C}=^{A}H_{B}·^{B}H_{C} (3)

Regarding the rotation matrix R, the same relationship as Expression (3) is established.

^{A}R_{C}=^{A}R_{B}·^{B}R_{C} (4)

### C. AX=XB Problem of Coordinate Transformation

In FIG. 3, the following transformation is established between the coordinate systems Σ_{A1}, Σ_{T1}, Σ_{E}, and Σ_{P}.
(1) Transformation ^{A1}H_{T1} (calculable): a transformation from the first arm coordinate system Σ_{A1} to the first hand coordinate system Σ_{T1}
(2) Transformation ^{T1}H_{E} (unknown): a transformation from the first hand coordinate system Σ_{T1} to the hand eye coordinate system Σ_{E}
(3) Transformation ^{E}H_{P} (estimable): a transformation from the hand eye coordinate system Σ_{E} to the pattern coordinate system Σ_{P}
(4) Transformation ^{P}H_{A1} (unknown): a transformation from the pattern coordinate system Σ_{P} to the first arm coordinate system Σ_{A1}

Among the above described four transformations ^{A1}H_{T1}, ^{T1}H_{E}, ^{E}H_{P}, and ^{P}H_{A1}, the transformation ^{A1}H_{T1} is transformation from the first arm coordinate system Σ_{A1} to the first hand coordinate system Σ_{T1}. The first hand coordinate system Σ_{T1} indicates position and attitude of the TCP of the first arm 160L. Normally, the process of acquiring the position and attitude of the TCP with respect to the first arm coordinate system Σ_{A1} is referred to as a forward kinematics, and is calculable if the geometric shape of the arm 160L and movement amount (rotation angle) of each joint are determined. In other words, the transformation ^{A1}H_{T1} is a calculable transformation.

The transformation ^{T1}H_{E} is a transformation from the first hand coordinate system Σ_{T1} to the hand eye coordinate system Σ_{E}. The transformation ^{T1}H_{E} is unknown, and acquiring the transformation ^{T1}H_{E} corresponds to the calibration of the hand eye 175.

The transformation ^{E}H_{P} is a transformation from the hand eye coordinate system Σ_{E} to the pattern coordinate system Σ_{P}, and can be estimated by capturing an image of the calibration pattern 400 with the hand eye 175, and performing image processing with respect to the image. The process of estimating the transformation ^{E}H_{P} can be executed using standard software (for example, camera calibration function of OpenCV or MATLAB) for performing camera calibration.

The transformation ^{P}H_{A1} is a transformation from the pattern coordinate system Σ_{P} to the first arm coordinate system Σ_{A1}. The transformation ^{P}H_{A1} is unknown.

Following the above-described transformations ^{A1}H_{T1}, ^{T1}H_{E}, ^{E}H_{P}, and ^{P}H_{A1} in order will lead to the initial first arm coordinate system Σ_{A1}, and the following expression will be established using an identity transformation I.

^{A1}H_{T1}·^{T1}H_{E}·^{E}H_{P}·^{P}H_{A1}=I (5)

The following expression can be acquired by multiplying inverse matrixes ^{A1}H_{T1}⁻¹, ^{T1}H_{E}⁻¹, and ^{E}H_{P}⁻¹ of each transformation in order from the left on both sides of Expression (5).

^{P}H_{A1}=^{E}H_{P}⁻¹·^{T1}H_{E}⁻¹·^{A1}H_{T1}⁻¹ (6)

In Expression (6), the transformation ^{E}H_{P} can be estimated from the camera calibration function, and the transformation ^{A1}H_{T1} is calculable. Accordingly, if the transformation ^{T1}H_{E} is known, the right side is calculable, and the transformation ^{P}H_{A1} on the left side can be known.

On the other hand, if the transformation ^{T1}H_{E} is unknown, the right side of Expression (6) is not calculable, and a different processing is required. For example, with consideration of two attitudes i and j of the left arm 160L in FIG. 3, above-described Expression (5) is established for each of the attitudes, and the following expressions are acquired.

^{A1}H_{T1}(i)·^{T1}H_{E}·^{E}H_{P}(i)·^{P}H_{A1}=I (7a)

^{A1}H_{T1}(j)·^{T1}H_{E}·^{E}H_{P}(j)·^{P}H_{A1}=I (7b)

The following expressions are acquired by multiplying an inverse matrix ^{P}H_{A1}⁻¹ of the transformation ^{P}H_{A1} on both sides of each Expressions (7a) and (7b) from the right.

^{A1}H_{T1}(i)·^{T1}H_{E}·^{E}H_{P}(i)=^{P}H_{A1}⁻¹ (8a)

(8b)

Although the right sides of Expressions (8a) and (8b) are unknown, since the expressions are the same transformation, the following expression is established.

^{A1}H_{T1}(i)·^{T1}H_{E}·^{E}H_{P}(i)=^{A1}H_{T1}(j)·^{T1}H_{E}·^{E}H_{P}(j) (9)

When multiplying ^{A1}H_{T1}(j)⁻¹ on the left side and ^{E}H_{P}(i)⁻¹ on the right side on both sides of Expression (9), the following expression is acquired.

(^{A1}H_{T1}(j)⁻¹·^{A1}H_{T1}(i))·^{T1}H_{E}=^{T1}H_{E}·(^{E}H_{P}(j)·^{E}H_{P}(i)⁻¹) (10)

Here, when the products of the transformation in parentheses of the left and the right sides of Expression (10) are written as A and B, and the unknown transformation ^{T1}H_{E} as X, following equation can be acquired.

AX=XB (11)

This is a well-known process as AX=XB problem, and a nonlinear optimization process is required to solve the unknown matrix X. However, there is a problem that there is no guarantee that the nonlinear optimization process will converge to an optimal solution.

As will be described in detail below, in a first embodiment, by calculating the relationship between the second arm coordinate system Σ_{A2} and the pattern coordinate system Σ_{P} from the position and attitude of the second arm 160R using the fact that the second arm 160R provide with the calibration pattern 400 can be optionally controlled, it is possible to estimate the transformation ^{T1}H_{E} or ^{E}H_{T1} between the first hand coordinate system Σ_{T1} and the hand eye coordinate system Σ_{E}. As a result, it is possible to determine the extrinsic parameter of the hand eye 175.

To perform such a process, in the first embodiment, the following transformations are used in addition to the above-described transformations ^{A1}H_{T1}, ^{T1}H_{E}, ^{E}H_{P}, and ^{P}H_{A1}.
(5) Transformation ^{A1}H_{A2} (known) : a transformation from the first arm coordinate system Σ_{A1} to the second arm coordinate system Σ_{A2}
(6) Transformation ^{A2}H_{T2} (calculable): a transformation from the second arm coordinate system Σ_{A2} to the second hand coordinate system Σ_{T2}
(7) Transformation ^{T2}H_{P} (known): a transformation from the second hand coordinate system Σ_{T2} to the pattern coordinate system Σ_{P}

The transformation ^{T2}H_{P} from the second hand coordinate system Σ_{T2} to the pattern coordinate system Σ_{P} is assumed to be known. If a tool (for example, flange) for installing the calibration pattern 400 in the wrist portion of the arm 160R is designed and manufactured with high accuracy, it is possible to determine the transformation ^{T2}H_{P} from the design data. Alternatively, an image of the calibration pattern 400 installed in the wrist portion of the arm 160R may be captured with the fixed camera 170, a transformation ^{C}H_{P} of a camera coordinate system Σ_{C} and the pattern coordinate system Σ_{P} may be estimated from the pattern image, and the transformation ^{T2}H_{P} from the second hand coordinate system Σ_{T2} to the pattern coordinate system Σ_{P} may be acquired using the transformation ^{C}H_{P}.

### D. Processing Procedure of First Embodiment

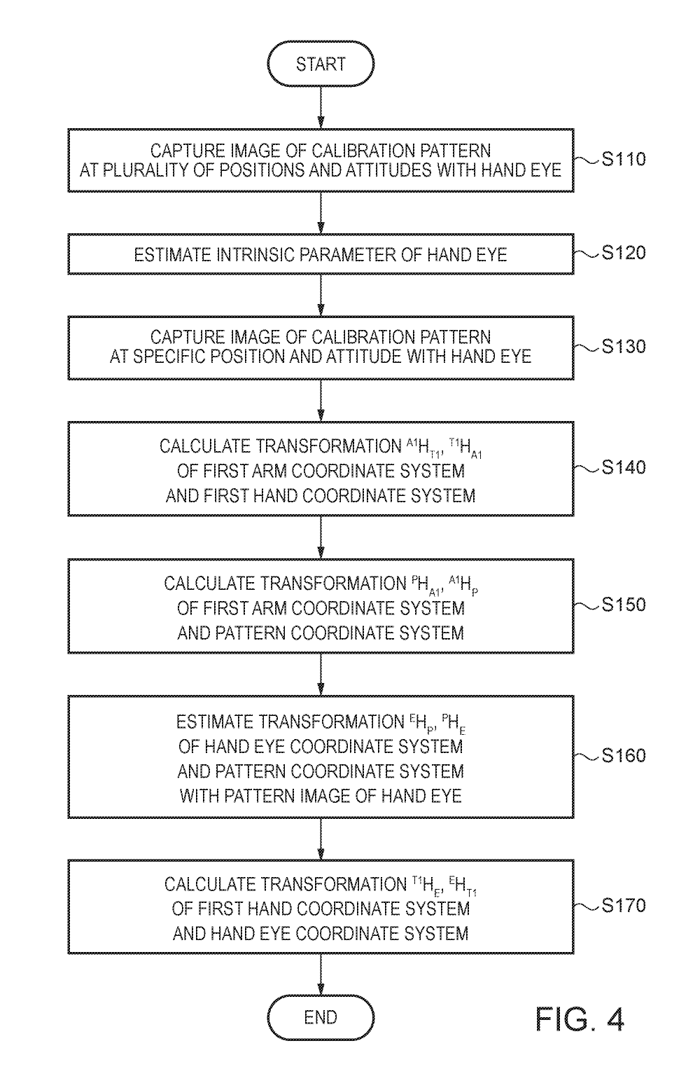

FIG. 4 is a flowchart illustrating a calibration processing procedure of the hand eye 175 in the first embodiment. The calibration of two hand eyes 175R and 175L provided in the robot 100 is separately performed, but the cameras will be referred to as “hand eye 175” without particular distinction below. The calibration processing described below is executed with cooperation of the arm control unit 211, the camera control unit 212, and the camera calibration execution unit 213 illustrated in FIG. 2. In other words, the operation of changing the position and attitude of the calibration pattern 400 is executed by the arm 160 being controlled by the arm control unit 211. The capturing of an image with the hand eye 175 and the camera 170 is controlled by the camera control unit 212. The intrinsic parameter and the extrinsic parameter of the hand eye 175 are determined by the camera calibration execution unit 213. In the determination of the extrinsic parameter of the hand eye 175, estimation of various matrixes and vectors are executed by the transformation matrix estimation unit 214.

Step S110 and step S120 are processes for determining the intrinsic parameter of the hand eye 175. First, in step S110, the images of the calibration pattern 400 are captured at a plurality of positions and attitudes using the hand eye 175. Since these plurality of positions and attitudes are to determine the intrinsic parameter of the hand eye 175, any position and attitude can be applied. Hereinafter, the image acquired from capturing the image of the calibration pattern 400 with the hand eye 175 is referred to as “pattern image”. In step S120, the camera calibration execution unit 213 estimates the intrinsic parameter of the hand eye 175 using the plurality of the pattern images acquired in step S110. As described above, the intrinsic parameter of the hand eye 175 is a specific parameter of the hand eye 175 and the lens system thereof and includes, for example, a projective transformation parameter, a distortion parameter, and the like. Estimation of the intrinsic parameter can be executed using standard software (for example, camera calibration function of OpenCV or MATLAB) for performing camera calibration.

The steps S130 to S170 are processes for estimating the extrinsic parameter of the hand eye 175. In step S130, the image of the calibration pattern 400 is captured at a specific position and attitude using the hand eye 175. In the above-described step S110, since the images of the calibration pattern 400 are captured at the plurality of positions and attitudes, one of these plurality of positions and attitudes may be used as “specific position and attitude”. In this case, step S130 is optional. Hereinafter, the state of the robot 100 that the calibration pattern 400 is taking the specific position and attitude is simply referred to as “specific position and attitude state”.

In step S140, the transformation _{A1}H_{T1} or ^{T1}H_{A1} between the first arm coordinate system Σ_{A1} and the first hand coordinate system Σ_{T1} in the specific position and attitude state is calculated. The transformation ^{A1}H_{T1} or ^{T1}H_{A1} can be calculated by the forward kinematics of the arm 160L.

In step S150, the transformation ^{A1}H_{P} or ^{P}H_{A1} between the first arm coordinate system Σ_{A1} and the pattern coordinate system Σ_{P} in the specific position and attitude state can be calculated. For example, the transformation ^{A1}H_{P} can be calculated with the following expression.

^{A1}H_{P}=^{A1}H_{A2}·^{A2}H_{T2}·^{T2}H_{P} (12)

Among the three transformations ^{A1}H_{A2}, ^{A2}H_{T2}, and ^{T2}H_{P} in the right side of Expression (12), the first transformation ^{A1}H_{A2} and the third transformation ^{T2}H_{P} are constant, and the second transformation ^{A2}H_{T2} is calculated by the position and attitude of the second arm 160R.

In this way, in step S150, the transformation ^{A1}H_{P} or ^{P}H_{A1} between the first arm coordinate system Σ_{A1} and the pattern coordinate system Σ_{P} can be calculated from the position and attitude of the second arm 160R in the specific position and attitude state. In other words, the camera calibration execution unit 213 can calculate the relationship between the first arm coordinate system Σ_{A1} and the pattern coordinate system Σ_{P} in the specific position and attitude state.

In step S160, the transformation ^{E}H_{P} or ^{P}H_{E} between the hand eye coordinate system Σ_{E} and the pattern coordinate system Σ_{P} can be estimated using the pattern image captured with the hand eye 175 in the specific position and attitude state. The estimation can be executed using standard software (for example, OpenCV function “FindExtrinsicCameraParams2”) for estimating the extrinsic parameter of the camera with the intrinsic parameter acquired in step S120.

In step S170, transformations ^{T1}H_{E}, and ^{E}H_{T1} of the first hand coordinate system and the hand eye coordinate system are calculated. For example, for the transformation ^{T1}H_{E}, the following expression is established in FIG. 3.

^{T1}H_{E}=^{T1}H_{A1}·^{A1}H_{A2}·^{A2}H_{T2}·^{T2}H_{P}·^{P}H_{E} (13)

Among the five transformations on the right side of Expression (13), the first transformation ^{T1}H_{A1} is calculated in step S140. The second transformation ^{A1}H_{A2} is known. The third transformation ^{A2}H_{T2} can be calculated by the forward kinematics of the arm 160R. The fourth transformation ^{T2}H_{P} is known. The fifth transformation ^{P}H_{E} is estimated in step S160. Thereby, the transformation ^{T1}H_{E} of the first hand coordinate system Σ_{T1} and the hand eye coordinate system ρ_{E} can be calculated according to Expression (13).

The acquired homogeneous transformation matrix ^{T1}H_{E} or ^{E}H_{T1} is stored in the non-volatile memory 230 as the extrinsic parameter 233 of the hand eye 175. It is possible to perform various detection process or control using the hand eye 175 with the extrinsic parameter 233 and the intrinsic parameter 232 of the hand eye 175. As the extrinsic parameter 233 of the hand eye 175, various parameters for calculating the coordinate transformation between the robot coordinate system Σ₀ and the hand eye coordinate system Σ_{E} can be applied.

In this way, in the first embodiment, it is possible to estimate the coordinate transformation matrix ^{T1}H_{E} between the first hand coordinate system Σ_{T1} and the hand eye coordinate system Σ_{E} using the position and attitude of the arm 160 at the time of capturing the pattern image and the pattern image. Particularly, in the first embodiment, the camera calibration execution unit 213 calculates the first transformation matrix ^{A1}H_{T1} or ^{T1}H_{A1} between the first arm coordinate system Σ_{A1} and the first hand coordinate system Σ_{T1} from the position and attitude of the arm 160 at the time of capturing the pattern image in step 5140. In step S150, a second transformation matrix ^{P}H_{A1} or ^{A1}H_{P} between the pattern coordinate system Σ_{P} and the first arm coordinate system Σ_{A1} is calculated. In step S160, the third transformation matrix ^{E}H_{P} or ^{P}H_{E} between the hand eye coordinate system EE and the pattern coordinate system Σ_{P} is estimated from the pattern image. In step S170, the coordinate transformation matrix ^{T1}H_{E} or ^{E}H_{T1} between the first hand coordinate system Σ_{T1} and the hand eye coordinate system Σ_{E} is calculated from these transformation matrixes. Thereby, it is possible to easily acquire the extrinsic parameter of the hand eye 175 including the coordinate transformation matrix ^{T1}H_{E} or ^{E}H_{T1} between the first hand coordinate system Σ_{T1} and the hand eye coordinate system Σ_{E}.

### E. Second Embodiment

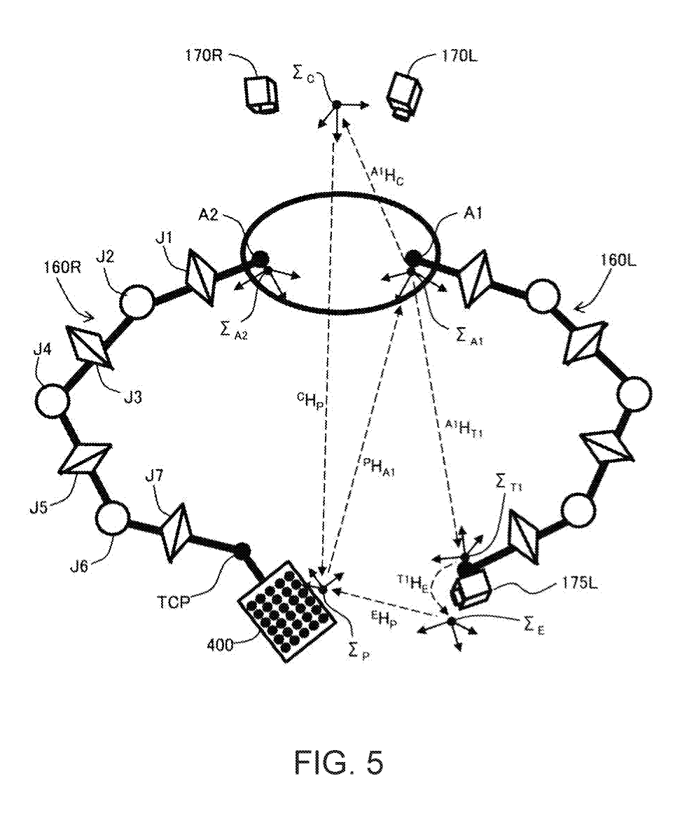

FIG. 5 is an explanatory diagram illustrating a coordinate system of the robot 100 in a second embodiment. The difference from FIG. 3 of the first embodiment is that the transformation ^{C}H_{P} or ^{P}H_{C} between the camera coordinate system Σ_{C} of the fixed camera 170 and the pattern coordinate system Σ_{P} is estimated using the fixed camera 170 instead of assuming that the transformation ^{T2}H_{P} from the second hand coordinate system Σ_{T2} to the pattern coordinate system Σ_{P} is known. The configuration of the robot 100 illustrated in FIGS. 1 and. 2 is the same as that of the first embodiment.

One or both of two cameras 170L and 170R is used as the fixed camera 170. It is possible to estimate the position and attitude of the calibration pattern 400 with higher accuracy by using two cameras 170L and 170R as stereo cameras. In the second embodiment, the calibration is assumed to be completed, and the intrinsic parameter and the extrinsic parameter are assumed to be determined in the camera 170. Assume that a transformation ^{A1}H_{C} between the first arm coordinate system Σ_{A1} and the camera coordinate system Σ_{C} is known.

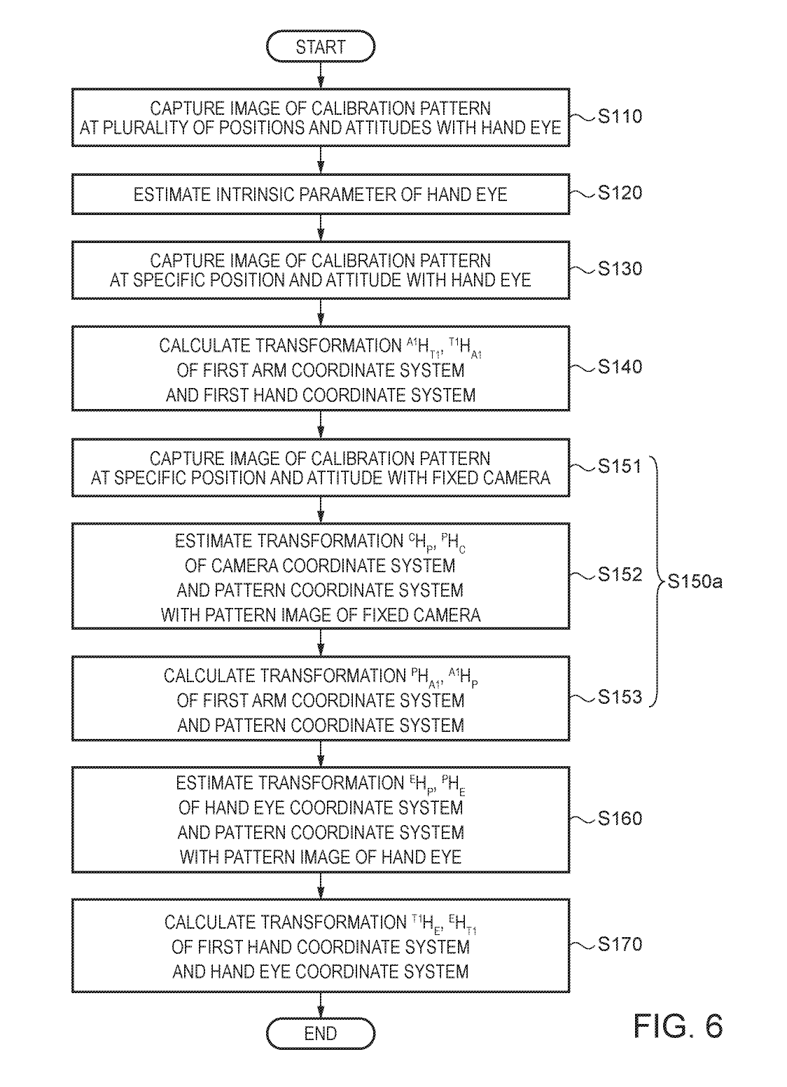

FIG. 6 is a flowchart illustrating the calibration processing procedure of the hand eye 175 in the second embodiment. The difference from FIG. 4 of the first embodiment is that step S150 in FIG. 4 is replaced with step S150a including three steps S151 to S153, and the other steps are the same.

In step S151, an image of the calibration pattern 400 is captured at the specific position and attitude using the fixed camera 170. The specific position and attitude is the same specific position and attitude in step S130. In step S152, the transformation ^{C}H_{P} or ^{P}H_{C} between the camera coordinate system Σ_{C} and the pattern coordinate system Σ_{P} is estimated using the pattern image (second pattern image) captured with the fixed camera 170 in the specific position and attitude state. For example, since the position and attitude of the pattern coordinate system Σ_{P} can be determined from the pattern image captured the calibration pattern 400 by using the fixed camera 170 as the stereo camera, the transformation ^{C}H_{P} or ^{P}H_{C} between the camera coordinate system Σ_{C} and the pattern coordinate system Σ_{P} can be estimated. On the other hand, in the case of using one fixed camera 170, it is possible to estimate the transformation ^{C}H_{P} or ^{P}H_{C} between the camera coordinate system ρ_{C} and the pattern coordinate system Σ_{P} using standard software (for example, OpenCV function “FindExtrinsicCameraParams2”) for estimating the extrinsic parameter of the camera.

In step S153, the transformation ^{A1}H_{P} or ^{P}H_{A1} between the first arm coordinate system Σ_{A1} and the pattern coordinate system Σ_{P} in the specific position and attitude state is calculated. For example, the transformation ^{A1}H_{P} can be calculated with the following expression.

^{A1}H_{P}=^{A1}H_{C}·^{C}H_{P} (14)

Between the two transformations on the right side of Expression (14), the first transformation ^{A1}H_{C} is known. The second transformation ^{C}H_{P} is estimated in step S152.

In this way, in the second embodiment, it is possible to estimate the transformation ^{A1}H_{P} or ^{P}H_{A1} between the first arm coordinate system Σ_{A1} and the pattern coordinate system Σ_{P} from the second pattern image captured with the fixed camera 170 in step S150a. In other words, the camera calibration execution unit 213 can estimate the relationship between the first arm coordinate system Σ_{A1} and the pattern coordinate system Σ_{P} in the specific position and attitude state.

When the transformation ^{A1}H_{P} or ^{P}H_{A1} between the first arm coordinate system Σ_{A1} and the pattern coordinate system Σ_{P} is determined, similarly to the first embodiment, by processing steps S160 and S170, it is possible to acquire the extrinsic parameter of the hand eye 175 including the homogeneous transformation matrix ^{T1}H_{E} or ^{E}H_{T1} of the first hand coordinate system Σ_{T1} and the hand eye coordinate system Σ_{E}.

In this way, in the second embodiment, it is possible to estimate the coordinate transformation matrix ^{T1}H_{E} between the first hand coordinate system Σ_{T1} and the hand eye coordinate system Σ_{E} using the position and attitude of the arm 160 at the time of capturing the pattern image and the pattern image. Particularly, in step S150a, the second pattern image of the calibration pattern 400 is captured with the fixed camera 170 disposed independently of the arm 160, and the second transformation matrix ^{A1}H_{P} or ^{P}H_{A1} between the pattern coordinate system Σ_{P} and the first arm coordinate system Σ_{A1} from the second pattern image is estimated in the second embodiment. In other words, since the second transformation matrix ^{A1}H_{P} or ^{P}H_{A1} can be estimated from the second pattern image, it is possible to easily acquire the coordinate transformation matrix ^{T1}H_{E} or ^{E}H_{T1} between the first hand coordinate system Σ_{T1} and the hand eye coordinate system Σ_{g}.

### F. Third Embodiment

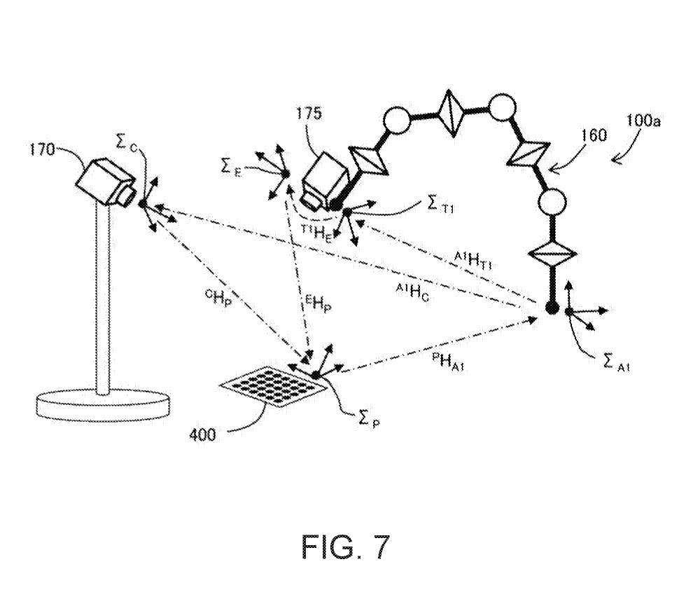

FIG. 7 is an explanatory diagram illustrating a coordinate system of a robot 100a in a third embodiment. The difference from FIG. 6 of the second embodiment is that the robot 100a is a single armed robot having one arm 160 and the fixed camera 170 is installed independently of the robot 100a. Similarly to the second embodiment, the transformation ^{A1}H_{C} between the arm coordinate system Σ_{A1} and the camera coordinate system Σ_{C} is assumed to be known. Since the processing procedure of the third embodiment is the same as the processing procedure of the second embodiment illustrated in FIG. 6, the description will be omitted.

Similarly to the second embodiment, it is possible to estimate the coordinate transformation matrix ^{T1}H_{E} or ^{E}H_{T1} between the hand coordinate system Σ_{T} and the hand eye coordinate system Σ_{E} using the position and attitude of the arm 160 at the time of capturing the pattern image and the pattern image in the third embodiment. In addition, it is possible to acquire the extrinsic parameter of the hand eye 175 including the coordinate transformation matrix ^{T1}H_{E} or ^{E}H_{T1}.

The invention is not limited to the above-described embodiments, examples, and modifications, and can be realized in various configurations without departing from the spirit thereof. For example, it is possible to replace or combine the technical features in the embodiments, examples, and modifications corresponding to the technical features in each embodiment described in the summary of the invention section as necessary in order to solve some or all of the above-mentioned problems or achieve some or all of the above effects. Unless the technical features are described as essential in the present specification, it can be deleted as appropriate.

The entire disclosure of Japanese Patent Application No. 2017-135107, filed Jul. 11, 2017 is expressly incorporated by reference herein.

What is claimed is:

1. A control device that controls a robot having an arm on which a camera is installed, comprising:
a processor that is configured to execute computer-executable instructions so as to control the robot,
wherein the processor is configured to:
cause the camera to capture a pattern image of a calibration pattern of the camera,
calculate a relationship between an arm coordinate system of the arm and a pattern coordinate system of the calibration pattern at the time of capturing the pattern image, and
estimate the coordinate transformation matrix with the relationship between the arm coordinate system and the pattern coordinate system, a position and attitude of the arm at the time of capturing the pattern image, and the pattern image.

2. The control device according to claim 1,
wherein the processor
calculates a first transformation matrix between the arm coordinate system and the hand coordinate system from the position and attitude of the arm at the time of capturing the pattern image,
calculates or estimates a second transformation matrix between the pattern coordinate system and the arm coordinate system,
estimates a third transformation matrix between the camera coordinate system and the pattern coordinate system from the pattern image, and
calculates the coordinate transformation matrix from the first transformation matrix, the second transformation matrix, and the third transformation matrix.

3. The control device according to claim 2,
wherein the robot has a second arm provided with the calibration pattern set in a predetermined installation state, and
wherein the processor calculates the second transformation matrix between the pattern coordinate system and the arm coordinate system from a position and attitude of the second arm at the time of capturing the pattern image.

4. The control device according to claim 2,
wherein the processor causes a fixed camera disposed independently of the arm to capture a second pattern image of the calibration pattern, and
wherein the processor estimates the second transformation matrix between the pattern coordinate system and the arm coordinate system from the second pattern image.

5. The control device according to claim 4,
wherein the fixed camera is a stereo camera.

6. A robot connected to the control device according to claim 1.

7. A robot connected to the control device according to claim 2.

8. A robot connected to the control device according to claim 3.

9. A robot connected to the control device according to claim 4.

10. A robot connected to the control device according to claim 5.

11. A robot system comprising:
a robot; and
the control device connected to the robot according to claim 1.

12. A robot system comprising:
a robot; and
the control device connected to the robot according to claim 2.

13. A robot system comprising:
a robot; and
the control device connected to the robot according to claim 3.

14. A robot system comprising:
a robot; and
the control device connected to the robot according to claim 4.

15. A robot system comprising:
a robot; and
the control device connected to the robot according to claim 5.

16. A robot system comprising:
a robot; and
the control device connected to the robot according to claim 6.

17. A calibration method of a camera for a robot having an arm on which the camera is installed, comprising:
causing the camera to capture a pattern image of a calibration pattern of the camera;
calculating a relationship between an arm coordinate system of the arm and a pattern coordinate system of the calibration pattern at the time of capturing the pattern image; and
estimating a coordinate transformation matrix between a hand coordinate system of the arm and a camera coordinate system of the camera with a position and attitude of the arm at the time of capturing the pattern image and the pattern image.
